(19) United States
(12) Patent Application Publication
(10) Pub. No.: US 2026/0145589 A1
(43) Pub. Date: May 28, 2026

(54) VEHICLE SEAT WITH A CONTROL SYSTEM AND CONTROL METHOD

(71) Applicant: BROSE FAHRZEUGTEILE SE & CO. KOMMANDITGESELLSCHAFT, COBURG, Coburg (DE)

(72) Inventors: Alexander CZEMPIK, Markkleeberg (DE); Alexander MÜLLER, Bischberg (DE); Florian POHL, Ebersdorf (DE); Stefan DIESTLER, Unterleinleiter/Dürrbrunn (DE); Alex KROMER, Stegaurach (DE)

(21) Appl. No.: 19/122,184

(22) PCT Filed: Oct. 16, 2023
(86) PCT No.: PCT/EP2023/078629

§ 371 Date: Aug. 22, 2025

(30) Foreign Application Priority Data
Oct. 17, 2022 (DE) 10 2022 127 128.5

(51) Int. Cl. B60N 2/02; B60N 2/66

(52) U.S. Cl. CPC B60N 2/0272; B60N 2/02246; B60N 2/0268; B60N 2/66

(57) ABSTRACT

It is provided a vehicle seat comprising a plurality of electrical drive units, two or more components which can each be adjusted by means of one of the electrical drive units, and a control system coupled to the electrical drive units.

### CROSS REFERENCE TO RELATED APPLICATIONS

The present application is a U.S. National Phase of International Application No. PCT/EP2023/078629 entitled “VEHICLE SEAT WITH A CONTROL SYSTEM AND CONTROL METHOD,” and filed on Oct. 16, 2023. International Application No. PCT/EP 2023/078629 claims priority to German Patent Application No. 10 2022 127 128.5 filed on Oct. 17, 2022. The entire contents of each of the above-listed applications are hereby incorporated by reference for all purposes.

### BACKGROUND

The proposed solution relates to a vehicle seat, a control method, a corresponding computer program product, and a non-volatile computer-readable storage medium.

Vehicle seats often are adjustable in a variety of ways, for instance in a vehicle longitudinal direction, in a height direction, with regard to a backrest inclination and with regard to the height of a headrest, to name only a few examples. Many modern vehicle seats therefor each comprise an electrical drive unit, each of which includes an electric motor.

In use of such vehicle seats it often is necessary to activate several or even all of the electrical drive units, in order to transfer the corresponding vehicle seat from one configuration into another one, e.g. during the change of a user, for setting a forward position in order to facilitate an entry into a rear seat row (also referred to as easy-entry position), for setting a loading position with the backrest folded down (also referred to as fold-flat position), or for rotating a vehicle seat also referred to as Captains Chair between a driving position oriented in the direction of travel and a position facing a vehicle interior.

When all electrical drive units to be activated are started at the same time, they will stop one after the other due to different adjustment times until reaching the respective target setting. This results in a potentially uncomfortable, jerky start of the adjustment. In addition, a sum current of the electrical drive units to be activated can exceed a maximum sum current, which is why individual ones of the electrical drive units must be deactivated. Their activation will be carried out as soon as allowed by the sum current of the activated electrical drive units, which however can result in a longer adjustment duration.

### SUMMARY

The object is to improve the control of vehicle seats.

This object is achieved by a vehicle seat with features as described herein.

Accordingly, a vehicle seat comprises a plurality of electrical drive units, a plurality of, e.g. two, three or more, components which can each be adjusted by means of one of the electrical drive units, and a control system coupled to the electrical drive units. The control system is adapted to carry out the following steps: determining in each case an actual position and a target position of at least two of the components (in particular of all components); determining in each case a value for an adjustment duration from the respective actual position to the respective target position of the at least two of the components with in each case a predetermined adjustment speed of the corresponding electrical drive unit and determining the component having the longest adjustment duration; determining a target adjustment speed for the electrical drive unit of at least one further component of the at least two of the components based on the value for the adjustment duration of the component having the longest adjustment duration; and activating the electrical drive units of the component having the longest adjustment duration and the at least one further component for adjusting at least one of these components from the respective actual position to the respective target position, wherein at least the electrical drive unit of the at least one further component is activated with the corresponding determined target adjustment speed.

This is based on the idea that an adaptation, in particular reduction, of the adjustment speed of the drive units arriving at the target more quickly with predetermined adjustment speeds can lead to a lower power demand of these drive units, so that all drive units can be activated at the same time without exceeding the maximum sum current. Thereby, cable cross-sections furthermore can be reduced and simpler electronic components can be used, which provides for reduced manufacturing costs and a lower total weight. In addition, a particularly smooth and comfortable adjustment can be achieved. The control system can be arranged on the vehicle seat, or alternatively at least partly be arranged outside the vehicle seat. The control system also can be a central control system of a vehicle with the vehicle seat.

The control system can be adapted for determining in each case a value for an adjustment duration from the respective actual position to the respective target position of all components with a respectively predetermined (e.g. nominal) adjustment speed of the corresponding electrical drive unit. Thus, the respective adjustment duration of the faster components can be adapted to the adjustment duration of the slowest component.

A target adjustment speed of the electrical drive unit of the component having the longest adjustment duration can be equal or be set equal to the predetermined adjustment speed. Alternatively or additionally, the target adjustment speed of the electrical drive units of the at least one further component can be set to a value which is smaller than the corresponding predetermined adjustment speed. The slowest component hence can be adjusted with the specified speed, while the faster component is adjusted with a lower speed than specified.

A respectively predetermined adjustment speed of the individual electrical drive units can represent the maximum adjustment speed of the respective electrical drive unit. Thus, the slowest component can be adjusted with the maximum speed, while the remaining components are adjusted with a speed which is less than the respective maximum speed.

The control system optionally is adapted to control the electrical drive units for adjusting the components in such a way that all of the drive units start within a short time window, in particular within an in particular predetermined time window, which e.g. amounts to 10%, 5% or only 1% of the adjustment duration of the component having the longest adjustment duration (and/or amounts to 0.5 seconds, 0.2 seconds or 0.1 seconds). In particular, the electrical drive units can start at the same time. This provides for a particularly comfortable adjustment.

Furthermore, the control system can be adapted to determine the target adjustment speed of the electrical drive unit of the at least one further component in such a way that the component having the longest adjustment duration and the at least one further component (in particular all components) arrive at the target position of the respective component within a predetermined (short) time window, in particular within a time window which amounts to 0.5 seconds, 0.2 seconds or 0.1 seconds. In particular, it can be provided that those components (in particular all components) arrive at the respective target position at the same time. This provides for a particularly comfortable adjustment in which the end of the adjustment is clearly visible for the user.

The control system can be adapted to control the electrical drive units for adjusting the components in such a way that a jerk of the adjustment is smaller than a predetermined maximum jerk. The jerk is the derivative of the acceleration according to time. For this purpose, the adjustment speed of at least one of the components can be varied during the adjustment, for example be increased more slowly than one or more others of the components. Thereby, a particularly smooth, but nevertheless fast adjustment can be effected.

One or more of the electrical drive units, in particular each of the electrical drive units, in each case can comprise a brushless d.c. motor. Such motors allow a particularly good setting of the adjustment speed by setting the rotational speed. In general, the adjustment speed can be dimensioned via the rotational speed. Alternatively or additionally, one or more of the electrical drive units comprise a brushed motor.

One of the components (e.g. the one having the longest adjustment duration or the further one) can be a seat part adjustable with respect to a seat height relative to a vehicle floor (along a linear or curved path). Alternatively or additionally, one of the components (e.g. the further one or the one having the longest adjustment duration) can be a base adjustable relative to the vehicle floor in another direction, e.g. along a longitudinal direction (for example at an angle, e.g. perpendicularly to the seat height). The base can carry the seat part.

It can be provided that one of the components is a tilt-adjustable backrest and/or that one of the components is a seat-depth-adjustable seat pan part and/or that one of the components is an adjustable lumbar support and/or that one of the components is an adjustable headrest and/or that one of the components is an adjustable armrest. In particular, the vehicle seat can comprise all of these components.

The vehicle seat can comprise a weight sensor for detecting a weight of a user sitting on the vehicle seat, wherein the control system is adapted to determine the target adjustment speed of the at least one of the electrical drive units of the components based on the detected weight. When it is included in the determination, an even better synchronized adjustment can be achieved.

Optionally, the control system is adapted to determine the target adjustment speed of the electrical drive unit of the at least one further component based on power demands of the electrical drive units and a predetermined maximum total power demand for the sum of the power demands of the electrical drive units. Thus, the adjustment speeds can be set in such a way that a specified maximum total power demand is not exceeded. For this purpose, the adjustment speed of at least one of the components can be varied during the adjustment, for example be increased more slowly than one or more others of the components.

According to one aspect, there is indicated a computer-implemented method for adjusting a device, in particular a vehicle seat, in particular the vehicle seat according to an arbitrary embodiment described herein. The device (in particular the vehicle seat) comprises a plurality of electrical drive units and two or more components, which can each be adjusted by means of one of the electrical drive units. The method comprises the following steps: determining in each case an actual position and a target position of at least two of the components; determining in each case a value for an adjustment duration from the actual position to the target position of the at least two of the components with in each case a predetermined adjustment speed of the corresponding electrical drive unit and determining the component having the longest adjustment duration; determining a target adjustment speed for the electrical drive unit of at least one further component of the at least two of the components based on the value for the adjustment duration of the component having the longest adjustment duration; and activating the electrical drive units of the component having the longest adjustment duration and the at least one further component for adjusting at least these two components from the respective actual position to the respective target position, wherein at least the electrical drive unit of the at least one further component is activated with the (corresponding) determined target adjustment speed.

The method can comprise steps according to the various embodiments of the control system described above.

According to one aspect there is indicated a computer program product, comprising commands which on execution by one or more computers (e.g. in the form of the control system described above) cause the same to carry out the method described above.

According to one aspect there is indicated a non-volatile computer-readable storage medium on which commands are stored, which on execution by one or more computers (e.g. in the form of the control system described above) cause the same to carry out the method described above.

### BRIEF DESCRIPTION OF THE DRAWINGS

The idea underlying the solution will be explained in detail below with reference to the exemplary embodiments illustrated in the Figures.

FIG. 1 shows a vehicle seat with a plurality of adjustable components in a first position of use.

FIG. 2 shows the vehicle seat as shown in FIG. 1 in a second position of use.

FIG. 3 shows a diagram for representing jerk, acceleration, speed and position during an adjustment of the vehicle seat as shown in FIG. 1.

FIG. 4 shows a method for controlling a vehicle seat.

### DETAILED DESCRIPTION

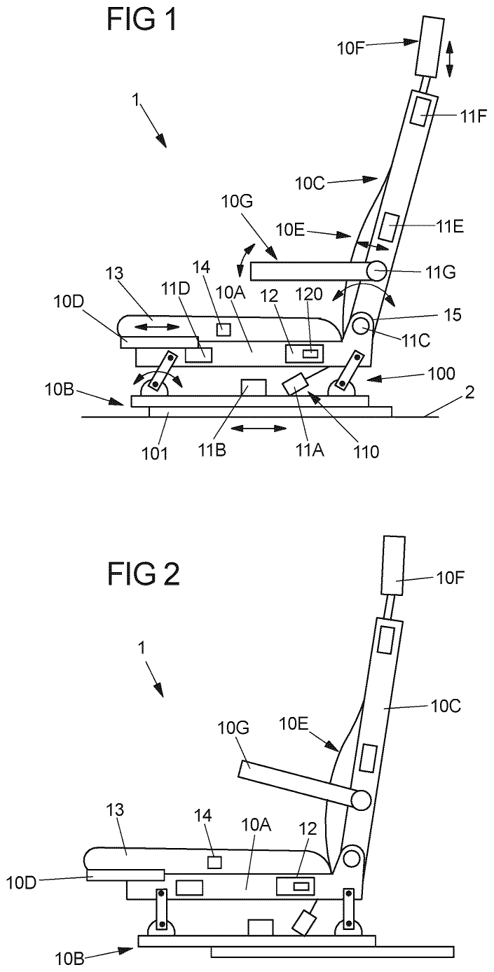

FIG. 1 shows a vehicle seat 1 comprising a plurality of adjustable components 10A-10G. Furthermore, the vehicle seat 1 comprises a plurality of electrical drive units 11A-11G, each for adjusting one of the components 10A-10G relative to other parts of the vehicle seat 1, and a control system 12 for controlling the electrical drive units 11A-11G. For this purpose, the electrical drive units 11A-11G are connected to the control system 12 via control cables (alternatively wirelessly). The vehicle seat 1 can also be referred to as a vehicle seat system.

FIG. 1 shows the vehicle seat 1 in a first position of use to be occupied. FIG. 2 shows the vehicle seat 1 in a second position of use to be occupied. In addition, the vehicle seat 1 can be transferred into an easy-entry position and into a fold-flat position.

One of the components 10A-10G is a seat part 10A on which a bolster 13 is mounted. Another one of the components 10A-10G is a backrest 10C. The seat part 10A is adjustably supported on a base 10B via a height adjusting mechanism 100, which base represents another one of the components 10A-10G.

In the present case, the height adjusting mechanism 100 (on both sides each) comprises a four-bar linkage with a front lever and a rear lever, wherein other configurations also are conceivable. The levers each are pivotally mounted on the seat part 10A and on the base 10B. Depending on the pivot position of the levers, the seat part 10A can be brought into a lowered position disposed closer to a vehicle floor 2, as shown in FIG. 1, or into a raised position more remote from the vehicle floor 2, as shown in FIG. 2. For the easy-entry position, the levers can be pivoted forwards even more. In the easy-entry position, e.g. entry into a seat row behind the vehicle seat 1 can be facilitated. To effect the adjustment of the seat part 10A relative to the base 10B an electrical drive unit 11A is provided. The electrical drive unit 11A comprises a brushless d.c. motor 110. Such motors also are briefly referred to as BLDC motors. The d.c. motor 110 can be operated with variable speed. A higher speed results in a larger power demand from the on-board network, a lower speed results in a lower power demand from the on-board network. The d.c. motor 110 here by way of example is coupled to a spindle via a transmission. The spindle is mounted on the seat part 10A, the d.c. motor 110 on the base 10B (alternatively e.g. the other way round) so that an activation of the electrical drive unit 10A adjusts the seat part 10A relative to the base 10B by a movement of the spindle relative to a spindle nut.

The base 10B is formed by seat-side rails of a rail assembly 101. In addition to the seat-side rails, the rail assembly 101 comprises floor-side rails which can be attached, and in the illustrated example, are attached to the vehicle floor 2. The seat-side rails are longitudinally shiftably guided on the floor-side rails. To effect an adjustment of the base 10B relative to the vehicle floor 2 (and to the floor-side rails) an electrical drive unit 11B is provided. The electrical drive unit 11B likewise comprises a BLDC motor which cooperates with a spindle. By activating the electrical drive unit 11B, the vehicle seat can be set in the longitudinal direction. While FIG. 1 shows a setting positioned further back, FIG. 2 illustrates a setting located further at the front. For the easy-entry position, the vehicle seat 1 can be positioned even further at the front.

The backrest 10C as one more component is pivotally mounted relative to the seat part 10A by means of tilt adjusters 15. To effect the adjustment, an electrical drive unit 11C is provided, which in this example likewise comprises a BLDC motor by means of which the tilt adjusters 25 are driven. The tilt adjusters for example are transmission fittings. While FIG. 1 shows a setting inclined further backwards, FIG. 2 illustrates a more upright setting. For the easy-entry position, the backrest 10C can be inclined even further forwards. For a fold-flat position, the backrest 10C can be folded onto the seat part 10A.

A seat pan part 10D as one more component is longitudinally adjustable for setting a seat depth relative to the seat part 10A. In a further retracted position of the seat pan part 10D, which is illustrated in FIG. 1, the bolster 13 has a lower seat depth than in an further extended position of the seat pan part 10D, which is illustrated in FIG. 2. To effect an adjustment of the seat pan part 10D, an electrical drive unit 11D is provided, which in turn by way of example comprises a BLDC motor.

In one more component in the form of a lumbar support 10E, the size and (alternatively or additionally) the position of a curvature can be set by means of an electrical drive unit 11E. FIG. 1 shows a weaker curvature, while FIG. 2 illustrates a stronger curvature.

A headrest 10F as one more component is adjustable in terms of its height relative to the backrest 10C (alternatively or additionally with respect to a position in the longitudinal direction). For this purpose, an electrical drive unit 11F in turn is provided. FIG. 1 shows a position located closer to the backrest 10C, while FIG. 2 shows a further extended position.

An armrest 10G as one more component can be set in terms of its inclination relative to the backrest 10C (alternatively or additionally in terms of its length and/or width) by means of a corresponding electrical drive unit 11G. FIG. 1 illustrates a horizontal setting, while FIG. 2 shows an inclined position.

The control system 12 is adapted to determine an actual position and a target position of at least two of the components 10A-10G. Concretely, the control system 12 is adapted to each determine an actual position and a target position of all of the components 10A-10G. For this purpose, the control system 12 communicates e.g. with the electrical drive units 11A-11G.

Furthermore, the control system 12 is adapted to determine a value for an adjustment duration from the actual position to the target position of at least the two (concretely of all) of the components 10A-10G in each case with a predetermined adjustment speed of the corresponding electrical drive unit 11A-11G. One of the components 10A-10G among them has the longest adjustment duration for adjusting from the respective actual position to the respective target position with the respectively predetermined adjustment speed of the respective electrical drive unit 11A-11G. This can be referred to as the component having the longest adjustment duration.

The control system 12 furthermore is adapted to determine a target adjustment speed for at least the electrical drive unit 11A-11G of a further one of the components 10A-10G based on the value for the adjustment duration of the component 10A-10G having the longest adjustment duration. In the present case, the control system 12 furthermore is adapted to determine a target adjustment speed for each of the electrical drive units 11A-11G. The target adjustment speed of the electrical drive unit 11A-11G of the component 10A-10G having the longest adjustment duration is set equal to the corresponding predetermined adjustment speed and the target adjustment speed of the electrical drive unit(s) 11A-11G of at least the one more of the components 10A-10G, in the present case of all of the remaining components 10A-10G, is set to a value which is smaller than the corresponding predetermined adjustment speed. The control system 12 comprises a non-volatile storage medium 120, in which the predetermined adjustment speeds are stored. The respectively predetermined adjustment speeds of the electrical drive units 11A-11G each are the maximum adjustment speed of the respective electrical drive unit 11A-11G.

Furthermore, the control system 12 is adapted to activate the electrical drive units 11A-11G of at least two of the components 10A-10G (concretely of all of the components) for adjusting at least the two (here all) of the components 10A-10G from the respective actual position to the respective target position, wherein at least the electrical drive unit 11A-11G of the further one of the components 10A-10G is activated with the target adjustment speed determined therefor.

For a particularly comfortable adjustment, the control system 12 furthermore is adapted to control the electrical drive units 11A-11G for adjusting the components 10A-10G in such a way that the drive units 11A-11G start at the same time (or at least start within a time window which amounts to 0.5 seconds, 0.2 seconds or 0.1 seconds and/or to 10%, 5% or 1% of the adjustment duration of the component 10A-10G having the longest adjustment duration). Optionally, the drive units 11A-11G are started and/or decelerated with a time offset. It thereby is possible, for example, to distribute increased start-up currents over time. The control system 12 in addition is adapted to determine the target adjustment speed of all electrical drive units 11A-11G except for the electrical drive unit of the component 10A-10G having the longest adjustment duration in such a way that all of the components 10A-10G arrive at the respective target position of the components 10A-10G at the same time or at least within a time window which amounts to 10%, 5% or 1% of the maximum adjustment duration.

The above-mentioned target adjustment speeds can be kept constant for the entire adjustment duration. Alternatively, the target adjustment speeds can also vary along the adjustment path.

To increase the accuracy of the synchronization of the adjustments, the vehicle seat 1 comprises an (optional) weight sensor 14 for detecting a weight of a user sitting on the vehicle seat 1. The control system 12 is adapted to determine the target adjustment speed and/or an operating current of the electrical drive unit 11A-11G at least of the further component 10A-10G, here of all electrical drive units 11A-11G, based on the detected weight. Some components 10A-10G are adjusted more slowly at a larger weight, e.g. the height adjustment, which can lead to the fact that the remaining components arrive at the respective target positions more quickly. This can be corrected by taking account of the weight.

Furthermore, the control system 12 is adapted to determine the target adjustment speed of the electrical drive unit 11A-11G at least of the further component 10A-10G, here of all electrical drive units 11A-11G, based on power demands of the electrical drive units 11A-11G and a predetermined maximum total power demand for the sum of the power demands of the electrical drive units 11A-11G. The adjustment speeds can be reduced, when necessary, so as not to exceed the maximum total power demand. For example in the case of a linear cabling of the drive units 11A-11G, the performance can be modeled and/or the position of the respective drive unit 11A-11G in the chain can be taken into account. For example, the drive units 11A-11G can be actuated (and/or their number can be determined) based on the respective position in the chain of the power supply, for example not simply a maximum of three drive units 11A-11G are activated, but a maximum of four in the first ones in the chain, only a maximum of two in the last ones, etc.

The target positions can be stored in the storage medium 120. For example, several users can each store a configuration of the vehicle seat 1.

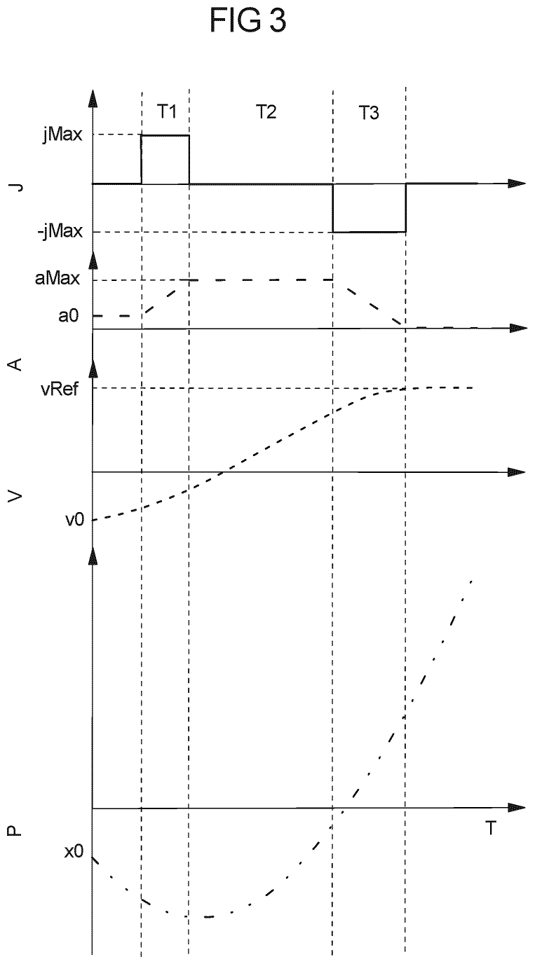

FIG. 3 shows the position P of a point on the vehicle seat 1 along the longitudinal axis proceeding from an initial position x0 against the time T, and the velocity V proceeding from an initial velocity v0, the acceleration A proceeding from an initial acceleration a0, and the jerk J. Several adjusting movements can overlap, so that a large jerk can occur when starting at the same time. To prevent this, the control system 12 is adapted to control the electrical drive units 11A-11G for adjusting the components 10A-10G in such a way that a jerk J of the adjustment is smaller than a predetermined maximum jerk +/−jMax. In a first time period T1 the jerk J is maximal, correspondingly the acceleration A rises and the velocity V correspondingly increases. In a second time period T2 the jerk J is equal to zero and the acceleration A correspondingly is constant with a maximum acceleration. In a third time period T3 the jerk J is minimal and the acceleration A correspondingly is reduced. Thereupon, jerk J and acceleration A are equal to zero and the velocity V is constant at a reference velocity vRef.

Optionally, the electrical drive units 11A-11G are controlled with varying target adjustment speeds such that one or more obstacles (e.g. a headliner) are bypassed.

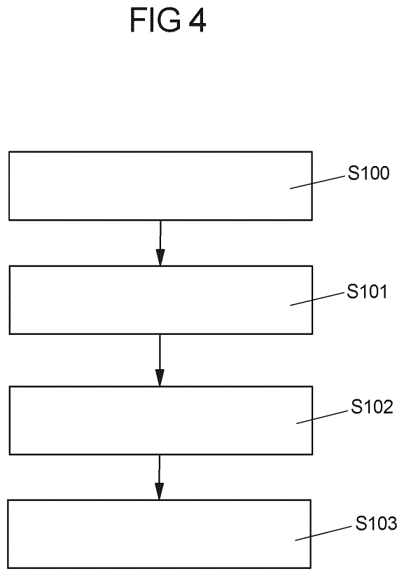

FIG. 4 shows a method for adjusting the vehicle seat 1, wherein the method is e.g. carried out by the control system 12 and comprises the following steps:
Step S100: determining an actual position and a target position of at least two (e.g. a first and a second) of the components 10A-10G (optionally of all components 10A-10G).

Step S101: determining in each case a value for an adjustment duration from the actual position to the target position of the at least two (or only of the first or all) of the components 10A-10G in each case with a predetermined adjustment speed of the corresponding electrical drive unit 11A-11G and, optionally, determining the component having the longest adjustment duration among the determined adjustment durations.

Step S102: determining a target adjustment speed for the electrical drive unit 11A-11G of at least one further (e.g. the second, in particular all remaining ones) of the at least two components 10A-10G based on the value for the adjustment duration of the (e.g. first) component 10A-10G having the longest adjustment duration. For example, the respective target adjustment speed is set such that the resulting set adjustment duration of the component 10A-10G is equal to the longest adjustment duration.

Step S103: activating the electrical drive units 11A-11G of the component 10A-10G having the longest adjustment duration and of the at least one further component 10A-10G (e.g. at least of the first and the second of the components 10A-10G) for adjusting at least those (e.g. all) components 10A-10G from the respective actual position to the respective target position, wherein at least the electrical drive unit 11A-11G of the at least one further (e.g. the second) component 10A-10G is activated with the (respectively) determined target adjustment speed.

In the storage medium 120 a computer program product is stored, comprising commands which on execution by the control system 12 cause the same to carry out the method described above.

### LIST OF REFERENCE NUMERALS

1 vehicle seat
10A seat part (component)
10B base (component)
10C backrest (component)
10D seat pan part (component)
10E lumbar support (component)
10F headrest (component)
10G armrest (component)
100 height adjusting mechanism
101 rail assembly
11A-11G electrical drive unit
110 d.c. motor
12 control system
120 storage medium
13 bolster
14 weight sensor
15 tilt adjuster
2 vehicle floor
A acceleration
a0 initial acceleration
aMax maximum acceleration
J jerk
jMax maximum jerk
P position
S100-S103 step
T time
T1-T3 time period
V velocity
v0 initial velocity
vRef reference velocity
x0 initial position

1. A vehicle seat comprising a plurality of electrical drive units, two or more components which each can be adjusted by means of one of the electrical drive units and a control system coupled to the electrical drive units, which is adapted to:
determine in each case an actual position and a target position of at least two of the components;
determine in each case a value for an adjustment duration from the actual position to the target position of the at least two of the components in each case with a predetermined adjustment speed of a corresponding electrical drive unit and determine a component having a longest adjustment duration;
determine a target adjustment speed for the electrical drive unit of at least one further of the at least two of the components based on a value for the adjustment duration of the component having the longest adjustment duration; and
activate the electrical drive units of the component having the longest adjustment duration and of the at least one further component for adjusting at least these components from the respective actual position to the respective target position, wherein at least the electrical drive unit of the at least one further component is activated with the correspondingly determined target adjustment speed.

2. The vehicle seat according to claim 1, wherein a target adjustment speed of the electrical drive unit of the component having the longest adjustment duration is equal to the predetermined adjustment speed, wherein the target adjustment speed of the electrical drive unit of the at least one further component is set to a value which is smaller than the corresponding predetermined adjustment speed.

3. The vehicle seat according to claim 1, wherein a respectively predetermined adjustment speed of the electrical drive units represents the maximum adjustment speed of the respective electrical drive unit.

4. The vehicle seat according to claim 1, wherein the control system is adapted to control the electrical drive units for adjusting the components in such a way that the drive units start, within a predetermined time window.

5. The vehicle seat according to claim 1, wherein the control system is adapted to determine the target adjustment speed of the electrical drive unit of the at least one further component in such a way that at least the component having the longest adjustment duration and the at least one further component arrive at the target position of the respective component within a predetermined time window.

6. The vehicle seat according to claim 1, wherein the control system is adapted to control the electrical drive units for adjusting the components in such a way that a jerk of the adjustment is smaller than a predetermined maximum jerk.

7. The vehicle seat according to claim 1, wherein the electrical drive units each comprise a brushless d.c. motor.

8. The vehicle seat according to claim 1, wherein one of the components is a seat part adjustable with respect to a seat height relative to a vehicle floor and one of the components is a base adjustable in another direction relative to the vehicle floor and carrying the seat part.

9. The vehicle seat according to claim 1, wherein one of the components is at least one of a tilt-adjustable backrest, a seat-depth-adjustable seat pan part, an adjustable lumbar support, an adjustable headrest and an adjustable armrest.

10. The vehicle seat according to claim 1, further comprising a weight sensor for detecting a weight of a user sitting on the vehicle seat, wherein the control system is adapted to determine at least one of the target adjustment speed and/or an operating current of the electrical drive unit of the at least one further component based on the detected weight.

11. The vehicle seat according to claim 1, wherein the control system is adapted to determine the target adjustment speed of the electrical drive unit of the at least one further component based on power demands of the electrical drive units and a predetermined maximum total power demand for the sum of the power demands of the electrical drive units.

12. A method for adjusting a device, comprising a plurality of electrical drive units and two or more components which can each be adjusted by means of one of the electrical drive units, the method comprising:
determining, by means of a control system, in each case an actual position and a target position of at least two of the components;
determining, by means of the control system, in each case a value for an adjustment duration from the actual position to the target position of the at least two of the components in each case with a predetermined adjustment speed of the corresponding electrical drive unit and determining the component having the longest adjustment duration;
determining, by means of the control system, a target adjustment speed for the electrical drive unit of at least one further of the at least two of the components based on the value for the adjustment duration of the component having the longest adjustment duration; and
activating, by means of the control system, the electrical drive units of the component having the longest adjustment duration and of the at least one further component for adjusting at least these components from the respective actual position to the respective target position, wherein at least the electrical drive unit of the at least one further component is activated with the correspondingly determined target adjustment speed.

13. (canceled)

14. A non-volatile computer-readable storage medium on which commands are stored, which on execution by one or more computers cause the same to carry out the method according to claim 12.
